(19) United States
(12) Patent Application Publication
(10) Pub. No.: US 2009/0059863 A1
(43) Pub. Date: Mar. 5, 2009

(54) Method and system of wireless communication for mobile voice data

(75) Inventors: Michael Chen, Hsin-Chu City (TW); Sue Yi-Shu Liu, Taipei City (TW); Sheng-Wang Hsieh, Tai-Chung City (TW)

Correspondence Address: BACON & THOMAS, PLLC, 625 SLATERS LANE, FOURTH FLOOR, ALEXANDRIA, VA, 22314-1176, US

(73) Assignee: Ruei Fon Hsin Ltd., Hsin-Chu (TW)

(21) Appl. No.: 12/000,116

(22) Filed: Dec. 10, 2007

(30) Foreign Application Priority Data
Aug. 30, 2007 (TW) 096132229

(51) Int. Cl. H04Q 7/00

(52) U.S. Cl. 370/331

(57) ABSTRACT

The present invention relates to a method and a system of wireless communicating voice data. When wireless communicating voice data, there is no need to collect the related information of the voice data into a multiple voice packet. Therefore, the ratio of the voice data in the multiple voice packet is increased remarkably to improve the efficiency of the wave band of the wireless communication. This method and the system therefore will provide high speed VoIP voice hand-over capability such that when the handset end-user is in high speed moving condition, the voice package can hand-over from one base station to next base station. For low power system such as WiFi, this method and the system thereof provides the best voice mobility capability.

### BACKGROUND OF THE INVENTION

1. Field of the Invention

The present invention relates to a method and system of wirelessly communicating voice data, and more particularly, to a method and system of wirelessly communicating voice data using a VoIP voice communication technique.

2. Description of Related Art

Nowadays, many companies start to provide services of communicating voice data using wireless communication techniques, and their services are widely accepted owing to the characteristics of low-cost and user-friendly voice communications, such as Voice over IP (VoIP). However, so far the communication quality of the system of wirelessly communicating voice data is still facing a lot of problems.

Please refer to FIG. 1, it illustrates a conventional system structure of communicating voice data using a wireless communication technique. As shown in FIG. 1, when a user is using a mobile voice communication device 1, such as using a mobile phone to wirelessly communicating voice data, partial voice data could be communicated to a router 4 via an base station 2 by means of a wireless communication technique, and then communicated from the router 4 to an upper-level gateway server device 5, then the gateway server device 5 would communicate the partial voice data to a designated user, such as another mobile voice communication device 1 within the coverage of an base station 6, while some partial voice data could be directly communicated to the router 4 via the mobile voice communication device 1. The voice data issued by the mobile voice communication device 1 is edited as a packet 11, wherein mark 11a represents valid areas of storing voice data, and mark 11b represents areas storing non-voice data, such as the resource of the voice data, a communication address, and so on. When the base station 2 receives the packet 11, it completely communicates the packet 11 to the router 4. Because the wave band of communicating voice data using the wireless communication technique is quite limited, a lot of wave band would be used to communicate non-voice data part 11b of the packet 11 between the base station 2 and the router 4 thereby reducing the efficient usage rate of the wave band. Further, when the number of mobile voice communication devices 1 performing wireless communications increases within the coverage of the base station 2, the data need to be processed by the base station 2 would be tremendously increased. Therefore, the above inefficient voice data communication method would cause a huge burden to the base station 2, and limit the number of users capable of being processed.

Further, please refer to both FIG. 2 and FIG. 3, which illustrate schematic drawings of a voice hand-over process procedure of U.S. Patent Application Serial No. 500194762. During the communication procedure, the user would probably cause a position movement of the mobile voice communication device 1, such as moving from the coverage of the base station 2 to the coverage of the base station 3, thereby triggering a voice hand-over process between the base station 2 and the base station 3. In FIG. 2, the base stations 2 and 3 are connected to the same router 4. That is, under a conventional system structure, the base stations 2 and 3 are arranged under an base station list managed by the same router 4. Therefore, when the base station 2 issues a signal to the router 4 requesting for a voice hand-over process, the router 4 could rapidly find the base station 3 from its base station list, and the base station 3 would also receive the signal issued by the mobile voice communication device 1, such that the router 4 could hand over the process right of the signal issued from the mobile voice communication device 1 to the base station 3.

On the other hand, please refer to FIG. 3, under certain circumstances, the user would probably cause the mobile voice communication device 1 to move to the coverage of an base station controlled by another router 7, such as moving from the coverage of the base station 2 controlled by the router 4 to the coverage of the base station 6 controlled by the router 7. However, under the conventional system structure, when the base station 2 issues a signal to the router 4 requesting for a voice hand-over process, at first the router 4 has to search for its managed base station list to determine if any base station receives the signal issued by the mobile voice communication device 1, and then searches for base stations managed by each neighbor routers. Therefore, it would take a lot of time to find out that the base station 6 receives the signal issued by the mobile voice communication device 1, and then the voice hand-over process procedure could be performed.

### SUMMARY OF THE INVENTION

One objective of the present invention is to provide a method and system of wirelessly communicating voice data, so as to improve the efficient usage rate of wirelessly communicating voice data.

Another objective of the present invention is to provide a method and system of wirelessly communicating voice data, so as to increase the number of users capable of being processed by a base station.

Another objective of the present invention is to provide a method and system of wirelessly communicating voice data, so as to reduce the time required by a voice hand-over process.

Yet another objective of the present invention is to provide a method and system of wirelessly communicating voice data, so as to provide high-speed VoIP voice mobility.

In order to achieve the above objectives, the present invention provides a method of wirelessly communicating voice data, comprising the following steps: using a first base station to receive a plurality of first voice packets; generating a multi-voice packet according to the plurality of first voice packets; and wirelessly communicating the multi-voice packet to a second base station.

In order to achieve the above objectives, the present invention further provides a system of wirelessly communicating voice data, comprising: a gateway server device; a first base station, wirelessly communicating with the gateway server device; a second base station, wirelessly communicating with the gateway server device; and a plurality of mobile voice communication devices, issuing a plurality of first voice packets to the first base station; wherein the first base station receives the first voice packets, generates a multi-voice packet according to the first voice packets, and the multi-voice packet would be wirelessly communicated to the second base station.

In the present invention, the format of the above first voice packets could be in the form of any wireless communication packet, such as in the form of a wireless IP phone. Preferably, the packet comprises a header section and a load section, wherein the header section is in front of the load section. More preferably, the packet is a VoIP (Voice over IP) packet. The above first voice packets could respectively comprise voice data, preferably recorded in the load section. And the multi-voice packet could comprise the voice data recorded in these first voice packets. The multi-voice packet could further comprise an address of the first base station and/or an address of the second base station so as to record their media access control codes, source addresses and destination addresses of the voice data, thereby communicating the voice data to an accurate second base station according to these addresses. Accordingly, when a handset end-user is in a high-speed moving condition, the voice data could be rapidly handed over to a next base station. Therefore, the method and system of the present invention could provide high-speed VoIP voice mobility capability between the first base station and the second base station, such as WiFi cellular system base stations.

Moreover, the first voice packet could further comprise information such as its media access control code, source address, destination address, user datagram protocol (UDP) and/or real-time transport protocol (RTP). Therefore, the present invention could further comprise a step of generating a registration table, so as to use the registration table to record the above media access control code, source address, destination address, UDP and/or RTP without collecting the information into the multi-voice packet, thereby remarkably increasing the ratio of voice data in the multi-voice packet. In the present invention, the above multi-voice packet could be communicated between the first base station and the gateway server device, and between the second base station and the gateway server device via a wireless voice communication technique, preferably via a VoIP voice communication technique to perform the wireless communication. Therefore, when re-collecting the multi-voice packet according to the first voice packets, the wave band occupied in order to communicate the source address, destination address, UDP and/or RTP would be reduced, thereby improving the efficient usage rate of the wave band of wirelessly communicating voice data, so as to increase the number of users capable of being processed by the first base station and the second base station.

Further, the present invention could further comprise the step of performing a voice hand-over process between the above first base station and another first base station. When a voice hand-over process between the first base station and another first base station is required, the present invention could update the source address of the first voice packets of the above registration table. In the present invention, because the wave band of wirelessly communicating voice data would be obviously and efficiently utilized, the time required by a voice hand-over process could be reduced.

### BRIEF DESCRIPTION OF THE DRAWINGS

FIG. 1 illustrates a conventional system structure of communicating voice data using a wireless communication technique.

FIG. 2 illustrates a schematic drawing of a conventional voice hand-over process procedure.

FIG. 3 illustrates a schematic drawing of another conventional voice hand-over process procedure.

FIG. 4 illustrates a system structure of communicating voice data using a wireless communication technique of one preferred embodiment according to the present invention.

FIG. 5 illustrates a format of a voice packet of one preferred embodiment according to the present invention.

FIG. 6 illustrates a format of a multi-voice packet of one preferred embodiment according to the present invention.

FIG. 7 illustrates a schematic drawing of a voice hand-over step of one preferred embodiment according to the present invention.

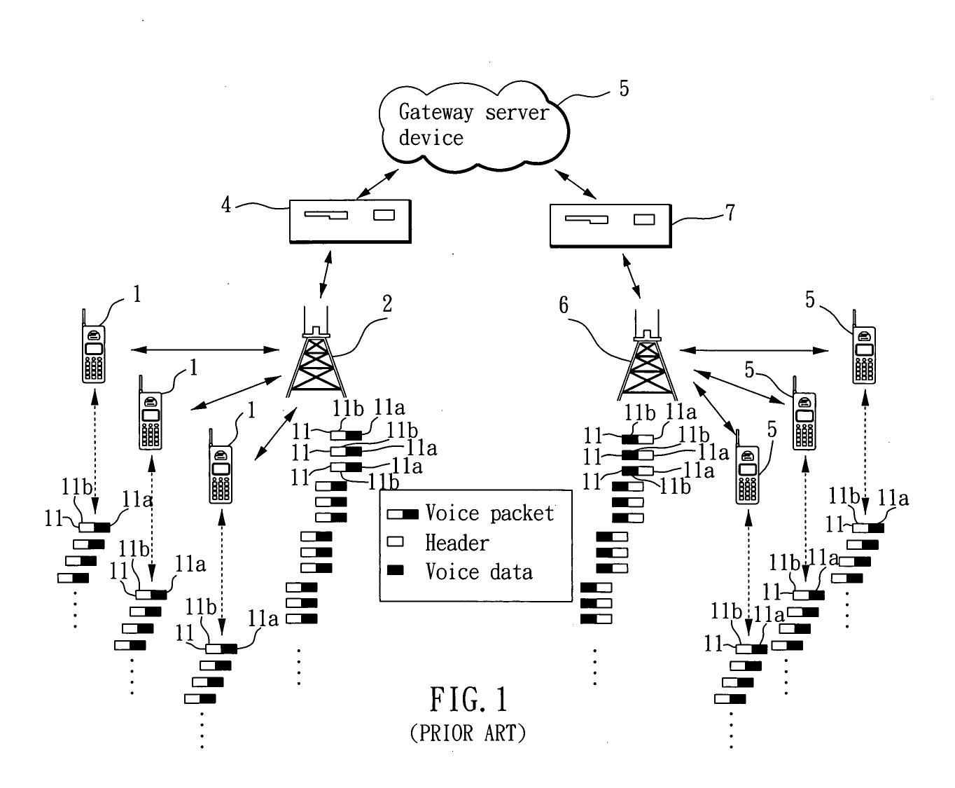

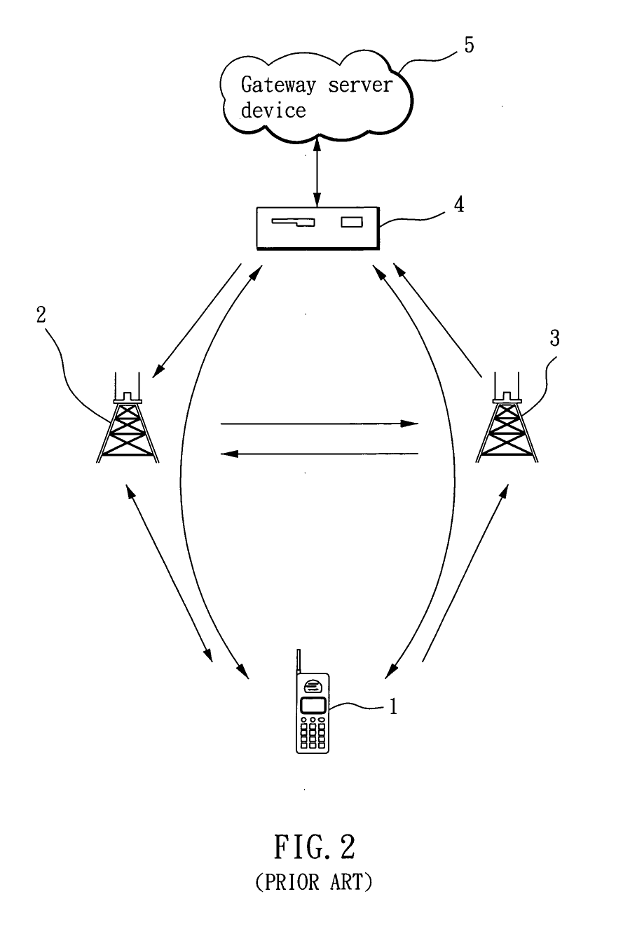

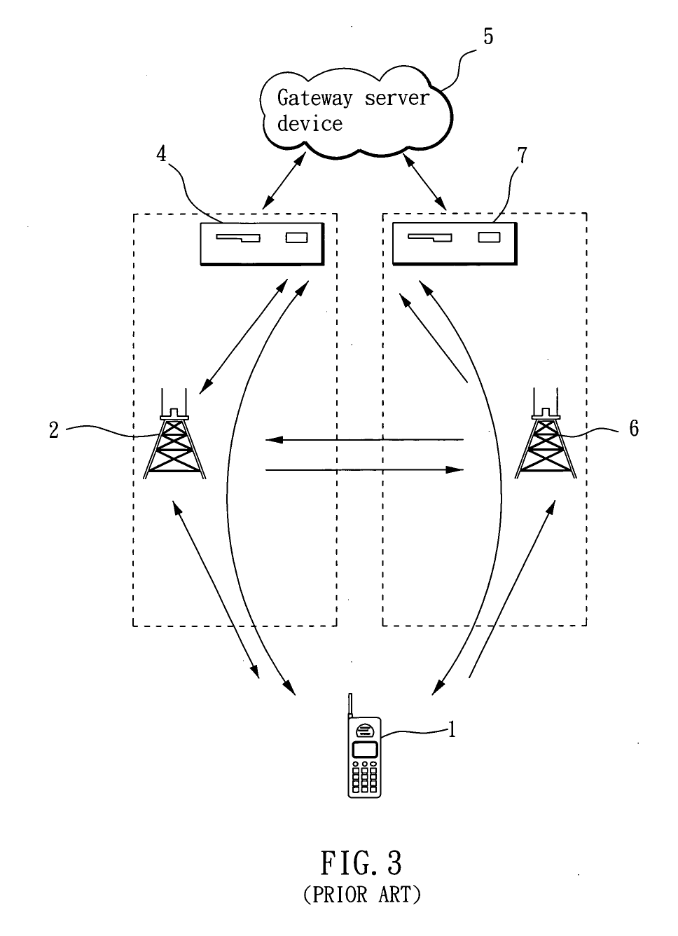

### DETAILED DESCRIPTION OF THE PREFERRED EMBODIMENT

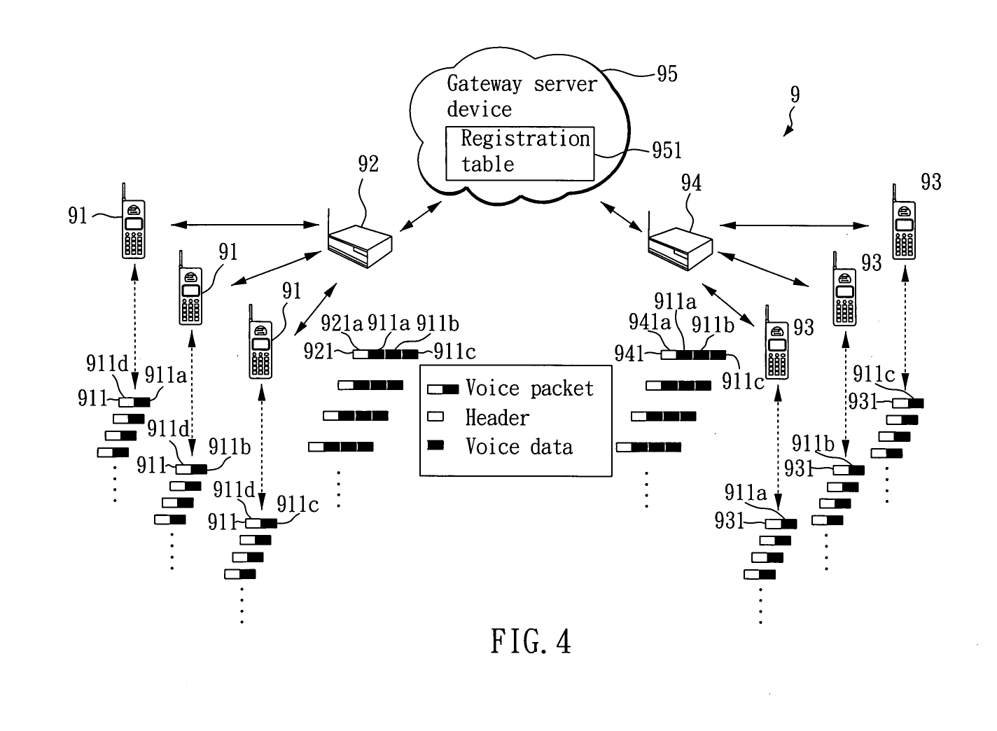

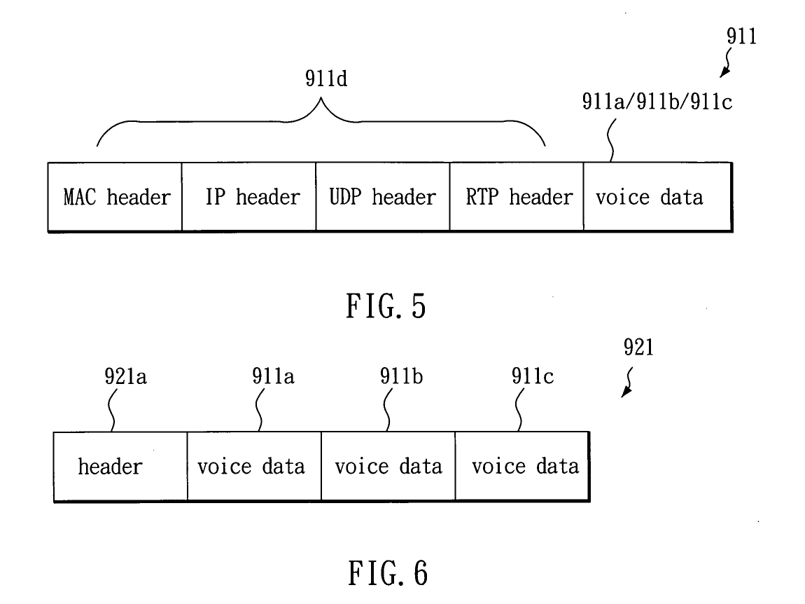

Please refer to FIG. 4, FIG. 5 and FIG. 6, wherein FIG. 4 illustrates a system structure of communicating voice data using a wireless communication technique of one preferred embodiment according to the present invention, while FIG. 5 and FIG. 6 respectively illustrate a format of a voice packet and a format of a multi-voice packet of one preferred embodiment according to the present invention.

As shown in FIG. 4, the system 9 of wirelessly communicating voice data comprises a gateway server device 95, a first base station 92, a second base station 94 and a plurality of mobile voice communication devices 91 and 93. Wherein, the mobile voice communication device 91 issues a plurality of first voice packets 911 to the first base station 92, and the first base station 92 and the second base station 94 respectively communicate with the gateway server device 95 by means of a wireless communication technique. In this embodiment, a user uses the mobile voice communication device 91 to communicate with a distant mobile voice communication device 93 through a VoIP (Voice over IP) service.

After being issued, the first voice packet 911 would be received by the first base station 92 via wireless communications. Please also refer to FIG. 5. As shown in FIG. 5, the first voice packet 911 comprises a header section 911d and a load section 911a, 911b and 911c. The header section 911d is in front of the load section 911a, 911b and 911c. In this embodiment, the header section 911d stores its media access control code in MAC header, source address and destination address in IP header, user datagram protocol (UDP) in UDP header, and real-time transport protocol (RTP) in RTP header. However, in other embodiments, the header section 911d could be configured as other storage spaces at different sizes, and could use other formats to store various kinds of information related to voice data. Load section 911a, 911b and 911c stores voice data. In this embodiment, the source address of the first voice packet 911 is the address of the first base station 92, and the destination address is the address of the second base station 94.

In this embodiment, for the purpose of a simple and clear description, three mobile voice communication devices 91 are all assumed to be within the coverage of the same base station 92. When the user uses the mobile voice communication device 91 to start an IP phone service, the first base station 92 respectively notifies the gateway server device 95 via wireless communications and generates a registration table 951 according to information recorded in the header section 911d of the first voice packet 911 issued by the mobile voice communication device 91. The registration table 951 correspondingly stores the media access control code, source address, destination address, UDP and/or RTP of the voice data issued by each mobile voice communication device 91. Further, if necessary, the registration table 951 could update above information during the process of using the IP phone service.

Then, the first base station 92 generates a multi-voice packet 921 according to these first voice packets 911, and wirelessly communicates the multi-voice packet 921 to the gateway server device 95. Please also refer to FIG. 6, the multi-voice packet 921 comprises the load sections 911a, 911b and 911c of each first voice packet 911, which means, the multi-voice packet 921 comprises the voice data stored in each first voice packet 911. Further, the multi-voice packet 921 comprises a header section 921a. The header section 921a of the embodiment only records the addresses of the first base station 92 and the second base station 94 without storing other information. Therefore, the ratio of non-voice data in the multi-voice packet 921 could be remarkably reduced, and the efficient usage rate of the wave band of wirelessly communicating voice data between the first base station 92 and the gateway server device 95 could be improved.

Next, the gateway server device 95 generates another multi-voice packet 941 so as to communicate the voice data stored in the multi-voice packet 921 into the destination address, where is the second base station 94. In this embodiment, the mobile voice communication device 93 which performs the IP phone service with the mobile voice communication device 91 is also within the coverage of the same second base station 94. Therefore, the gateway server device 95 could collect the load section 911a, 911b and 911c stored in the multi-voice packet 921 into the multi-voice packet 941, whose header section 941a records the addresses of the first base station 92 and the second base station 94.

Then, the second base station 94 generates a plurality of second voice packets 931 according to the multi-voice packet 941, wherein the second voice packets 931 respectively comprise a load section 911a, 911b and 911c, and then respectively communicates the second voice packets 931 to the mobile voice communication device 93.

Therefore, according to the above description, in the present invention, when wirelessly communicating voice data, there is no need to collect relevant information other than voice data into the multi-voice packet, therefore remarkably increasing the ratio of the voice data in the multi-voice packet, so as to improve the efficient usage rate of the wave band of wirelessly communicating the voice data, as well as increasing the number of users capable of being processed by the base station.

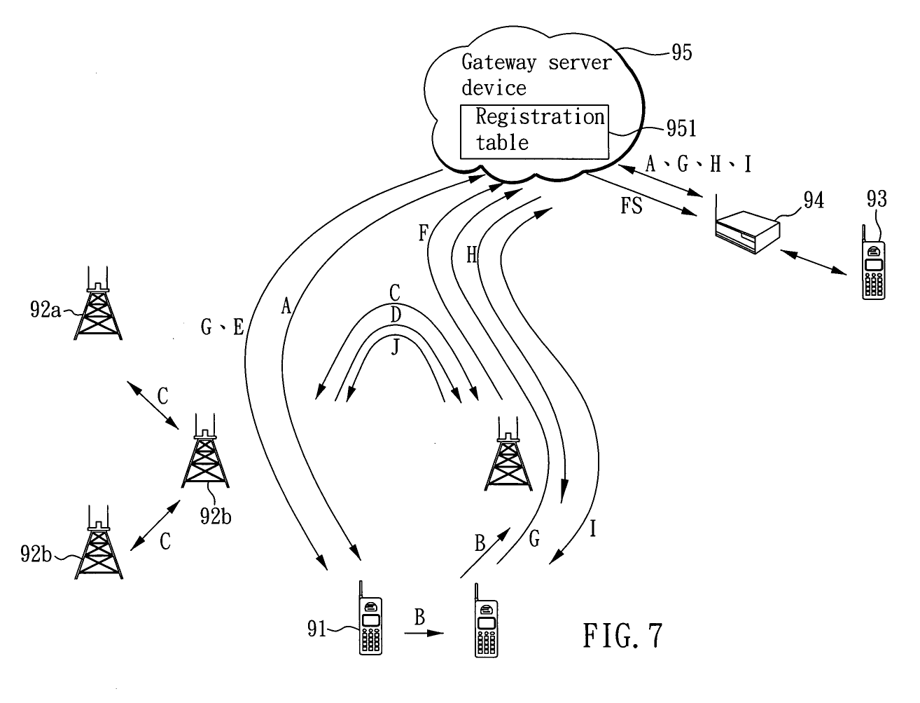

Please refer to FIG. 7, which illustrates a schematic drawing of a voice hand-over step of performing a hand-over process between the first base station 92 and another first base station 92c of one preferred embodiment according to the present invention. As shown in FIG. 7, at first, as indicated by arrowhead A, the mobile voice communication device 91 performs voice communications with the mobile voice communication device 93 via the first base station 92, the gateway server device 95 and the second base station 94. Then, as indicated by arrowhead B, if the user causes the mobile voice communication device 91 to move into the coverage of the first base station 92c, which means the mobile voice communication device 91 could also communicate with the first base station 92c. Next, as indicated by arrowhead C, when the first base station 92 decides to perform a voice hand-over process, the first base station 92 would firstly search for neighbor first base stations 92a, 92b and 92c, then it would find out that the first base station 92c could also receive the first voice packet 911 of the mobile voice communication device 91. Afterwards, as indicated by arrowhead D, the first base station 92 decides to hand over the process right of the signal issued from the mobile voice communication device 91 to the first base station 92c, and notify the first base station 92c to perform the voice hand-over process. Then, as indicated by arrowhead E, the first base station 92 only communicates the voice data, such as the second voice packets (not shown in FIG. 7), from the mobile voice communication device 93 to the mobile voice communication device 91 without receiving the voice data, such as the first voice packets (not shown in FIG. 7), issued by the mobile voice communication device 91. Next, as indicated by arrowhead F, the first base station 92c updates the registration 951 of the gateway server device 95. For example, it updates the source address of the first voice packets 911 from the address of the first base station 92 to the address of the first base station 92c. And then the first base station 92c starts to activate the function of receiving the voice data issued from the mobile voice communication device 91 and communicating the voice data from the mobile voice communication device 93 to the mobile voice communication device 91. However, at this time, the first base station 92c has not received any voice data need to be communicated to the mobile voice communication 91 yet. Before completing the update, as indicated by arrowhead G, the mobile voice communication device 93 communicates voice data to the mobile voice communication device 91 via the first base station 92. However, it is the first base station 92c which receives the voice data of the mobile voice communication device 91. After completing the update, as indicated by arrowhead H, the first base station 92c is also in charge of communicating the data from the mobile voice communication device 93 to the mobile voice communication device 91. Then, as indicated by arrowhead I, the first base station 92c is further in charge of communicating the voice data issued by the mobile voice communication device 91 and receiving the voice data from the mobile voice communication device 91. Then, the first base station 92c notifies the first base station 92 to release all resources related to the mobile voice communication device 91 and end the voice hand-over process. Although the above voice hand-over process requires a lot of procedures, the wave band of wirelessly communicating voice data in the present invention is obviously and efficiently utilized, thereby reducing the time required by the voice hand-over process and providing high-speed VoIP voice mobility capability.

Although the present invention has been explained in relation to its preferred embodiment, it is to be understood that many other possible modifications and variations can be made without departing from the spirit and scope of the invention as hereinafter claimed.

What is claimed is:

1. A method of wirelessly communicating voice data, comprising the following steps:
using a first base station to receive a plurality of first voice packets;
generating a multi-voice packet according to the plurality of first voice packets; and
wirelessly communicating the multi-voice packet to a second base station.

2. The method of wirelessly communicating voice data as claimed in claim 1, wherein the plurality of first voice packets comprise a header section and a load section, and the header section is in front of the load section.

3. The method of wirelessly communicating voice data as claimed in claim 2, wherein the load section respectively records voice data.

4. The method of wirelessly communicating voice data as claimed in claim 1, wherein the first voice packet further comprises its media access control code.

5. The method of wirelessly communicating voice data as claimed in claim 1, wherein the first voice packet further comprises its source address.

6. The method of wirelessly communicating voice data as claimed in claim 1, wherein the first voice packet further comprises its destination address.

7. The method of wirelessly communicating voice data as claimed in claim 1, wherein the first voice packet further comprises its user datagram protocol (UDP).

8. The method of wirelessly communicating voice data as claimed in claim 1, wherein the plurality of first voice packets respectively comprise voice data, and the multi-voice packet comprises the voice data of the plurality of first voice packets.

9. The method of wirelessly communicating voice data as claimed in claim 1, wherein the multi-voice packet comprises an address of the first base station.

10. The method of wirelessly communicating voice data as claimed in claim 1, wherein the multi-voice packet comprises an address of the second base station.

11. The method of wirelessly communicating voice data as claimed in claim 1, further comprising the step of generating a registration table.

12. The method of wirelessly communicating voice data as claimed in claim 11, wherein the first voice packet further comprises its media access control code.

13. The method of wirelessly communicating voice data as claimed in claim 11, wherein the registration table comprises a source address of the plurality of first voice packets.

14. The method of wirelessly communicating voice data as claimed in claim 11, wherein the registration table comprises a destination address of the plurality of first voice packets.

15. The method of wirelessly communicating voice data as claimed in claim 11, wherein the registration table comprises a user datagram protocol (UDP) of the plurality of first voice packets.

16. The method of wirelessly communicating voice data as claimed in claim 11, wherein the registration table comprises a real-time transport protocol (RTP) of the plurality of first voice packets.

17. The method of wirelessly communicating voice data as claimed in claim 1, wherein multi-voice packet is communicated by means of a VoIP voice communication technique.

18. The method of wirelessly communicating voice data as claimed in claim 1, further comprising the step of generating a plurality of second voice packets according to the multi-voice packet, wherein the plurality of second voice packets respectively record voice data.

19. The method of wirelessly communicating voice data as claimed in claim 1, further comprising the step of performing a voice hand-over process between the first base station and another first base station.

20. The method of wirelessly communicating voice data as claimed in claim 19, wherein a voice hand-over process comprises the step of updating a registration table.

21. The method of wirelessly communicating voice data as claimed in claim 20, wherein the registration table comprises a source address of the plurality of first voice packets, and the voice hand-over process comprises the step of updating the source address of the first voice packets of the registration table.

22. A system of wirelessly communicating voice data, comprising:
a gateway server device;
a first base station, wirelessly communicating with the gateway server device;
a second base station, wirelessly communicating with the gateway server device; and
a plurality of mobile voice communication devices, issuing a plurality of first voice packets to the first base station;
wherein the first base station receives the plurality of first voice packets, generates a multi-voice packet according to the plurality of first voice packets, and the multi-voice packet would be wirelessly communicated to the second base station.

23. The system of wirelessly communicating voice data as claimed in claim 22, wherein the plurality of first voice packets respectively comprise voice data, and the multi-voice packet comprises the voice data of the plurality of first voice packets.

24. The system of wirelessly communicating voice data as claimed in claim 22, wherein the gateway server device further comprises a registration table, the registration table comprises a media access control code of the plurality of first voice packets, a source address of the plurality of first voice packets, a destination address of the plurality of first voice packets, a user datagram protocol (UDP) of the plurality of first voice packets and a real-time transport protocol (RTP) of the plurality of first voice packets.

25. The system of wirelessly communicating voice data as claimed in claim 22, wherein the multi-voice packet is communicated by means of a VoIP voice communication technique.

26. The system of wirelessly communicating voice data as claimed in claim 22, wherein the first base station is a small cellular system base station.

27. The system of wirelessly communicating voice data as claimed in claim 22, wherein the second base station is a small cellular system base station.
